(19) United States
(12) Patent Application Publication
(10) Pub. No.: US 2023/0398442 A1
(43) Pub. Date: Dec. 14, 2023

(54) GAMING SERVICE RATING DETERMINATION

(71) Applicant: VEEGO SOFTWARE LTD., Ramat Gan (IL)

(72) Inventors: Ronen KONDRATOVSKY, Petah Tikva (IL); Sergey VOLKOVICH, Rehovot (IL); Reffael CASPI, Tel Aviv (IL)

(21) Appl. No.: 18/209,020

(22) Filed: Jun. 13, 2023

Related U.S. Application Data
(60) Provisional application No. 63/351,522, filed on Jun. 13, 2022.

(51) Int. Cl. A63F 13/358; A63F 13/355; H04L 43/0852; H04L 43/0829

(52) U.S. Cl. CPC A63F 13/358; A63F 13/355; H04L 43/0852; H04L 43/0829

(57) ABSTRACT

A computer-implemented method comprising: receiving, at a communications network interface, telemetry data representing data connections associated with a gaming service instance provided to an end-device by a remote gaming server over the Internet; selecting a subset of the data connections, based on data traffic measurements associated with each of the data connections; recursively, with respect to each current time window: (i) calculating a plurality of latency metrics over the subset of data connections, (ii) determining a current latency score of the gaming service instance, based on the plurality of latency metrics, (iii) updating a current Quality of Service (QoS) rating for the gaming service instance, based, at least in part, on the current latency score, and (iv) repeating steps (i)-(iii) with respect to a next time window.

### CROSS-REFERENCE TO RELATED APPLICATIONS

This application claims the benefit of priority from U.S. Provisional Patent Application No. 63/351,522, filed Jun. 13, 2022 entitled, “GAMING SERVICE RATING DETERMINATION,” the contents of which are hereby incorporated by reference in their entirety.

### FIELD OF THE INVENTION

The invention relates to the field of data communication networks.

### BACKGROUND

Maintaining an adequate level of service for online services and applications is essential for attracting and retaining customers for these services.

The inherent variability in the quality of service (QoS) achieved by various end-devices drives many complaints to network Internet Service Providers (ISPs). In turn, the QoS of the final network segment has a significant effect on the quality of experience (QoE) of the customer operating the end-device. For ISPs, the performance of home or residential networks is a particular problem, because it is largely beyond the control of, and invisible to, the ISPs, although it may be the ultimate cause of a large number of calls to ISP helplines.

Different web applications, such as gaming, media streaming, or audio/video live conferencing, have different traffic patterns and associated Quality of Service (QoS) requirements, in terms of bandwidth, latency, loss, delay, jitter (variation in delay), and best-effort options.

For instance, online gaming applications are particularly sensitive to latency, or the amount of time it takes a data packet to make its trip to a remote server and back. Accordingly, to properly determine the QoS experienced by a gaming user, it is vital for content providers to monitor a set of QoS parameters such as latency, jitter, and throughput assurances that are essential to this type of service.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in an embodiment, a system comprising: at least one hardware processor; and a non-transitory computer-readable storage medium having stored thereon program instructions, the program instructions executable by the at least one hardware processor to: receive, at a communications network interface, telemetry data representing data connections associated with a gaming service instance provided to an end-device by a remote gaming server over the Internet, select a subset of the data connections, based on data traffic measurements associated with each of the data connections, recursively, with respect to each current time window: (i) calculate a plurality of latency metrics over the subset of data connections, (ii) determine a current latency score of the gaming service instance, based on the plurality of latency metrics, (iii) update a current Quality of Service (QoS) rating for the gaming service instance, based, at least in part, on the current latency score, and (iv) repeat steps (i)-(iii) with respect to a next time window.

There is also provided in an embodiment, a computer-implemented method comprising: receiving, at a communications network interface, telemetry data representing data connections associated with a gaming service instance provided to an end-device by a remote gaming server over the Internet; selecting a subset of the data connections, based on data traffic measurements associated with each of the data connections; recursively, with respect to each current time window: (i) calculating a plurality of latency metrics over the subset of data connections, (ii) determining a current latency score of the gaming service instance, based on the plurality of latency metrics, (iii) updating a current Quality of Service (QoS) rating for the gaming service instance, based, at least in part, on the current latency score, and (iv) repeating steps (i)-(iii) with respect to a next time window.

There is further provided, in an embodiment, a computer program product comprising a non-transitory computer-readable storage medium having program instructions embodied therewith, the program instructions executable by at least one hardware processor to: receive, at a communications network interface, telemetry data representing data connections associated with a gaming service instance provided to an end-device by a remote gaming server over the Internet; select a subset of the data connections, based on data traffic measurements associated with each of the data connections; recursively, with respect to each current time window: (i) calculate a plurality of latency metrics over the subset of data connections, (ii) determine a current latency score of the gaming service instance, based on the plurality of latency metrics, (iii) update a current Quality of Service (QoS) rating for the gaming service instance, based, at least in part, on the current latency score, and (iv) repeat steps (i)-(iii) with respect to a next time window.

In some embodiments, the subset of data connections comprises between 1-8 of the data connections having a highest rate of date traffic.

In some embodiments, the plurality of latency metrics comprises one or more of the following metrics representing packet roundtrip time values over the subset of data connections: mean, average, maximum, minimum, or standard deviation.

In some embodiments, the current latency score is determined by applying a multivariate function to at least two of the latency metrics.

In some embodiments, the calculating further comprises calculating a packet loss score, based on a plurality of packet loss metrics comprising one or more of the following metrics representing packet loss over the subset of data connections: mean, average, maximum, minimum, or standard deviation.

In some embodiments, the current QoS is updated based on one of the following methods: selecting the lowest of the latency and packet loss scores, or applying predefined weights to the latency and packet loss scores.

In some embodiments, the time window has a duration of between 1-240 seconds.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 illustrates an exemplary gaming network environment which may provide for real-time monitoring and evaluating of the overall quality of an online gaming service connection, in accordance with various aspects of the present disclosure;

FIG. 2 shows a block diagram of an exemplary system for real-time monitoring and evaluating of the overall quality of an online gaming service connection, in accordance with some embodiments of the present disclosure;

FIG. 3 illustrates the functional steps in a method for real-time monitoring and evaluating of the overall quality of an online gaming service connection, in accordance with some embodiments of the present disclosure;

FIG. 4 shows an exemplary scoring flowchart of the present technique, in accordance with some embodiments of the present disclosure; and

FIG. 5 shows a plot of an exemplary multivariate function, in accordance with some embodiments of the present disclosure.

### DETAILED DESCRIPTION

Disclosed herein is a technique, embodied in a system, method and computer program product, for real-time monitoring and evaluating of the overall quality of an online gaming service connection. Embodiments described herein are directed to approaches for determining a quality of experience (QoE) of a user of an end-device or end-station within a communications network, which executes an online gaming application. In some embodiments, the service connection may be a wired or wireless link between an online gaming source over a communication network delivery path to the end-station.

Online video gaming allows users to engage in a gaming experience on a gaming service platform. Online video gaming also allows users to interact with one another in a specific game, wherein each user is playing the game using Customer Premises Equipment (CPE) (such as a personal computer or game consoles), which is connected by a carrier network maintained by an Internet service provider (ISP) to a gaming service. The carrier network extends from the location of each user, through an intermediate network (such as an access network or a wide-area network), to the Internet. The gaming service is also connected to the intermediate network directly or indirectly via the Internet.

Gaming experience for participants is dependent on the speed and quality of data transmission over their respective network connections. Data transmission includes a downstream data path and an upstream data path. Downstream paths normally refer to transmission from a web server to a workstation or personal computer user. Upstream data transmission is the opposite, with data originating in the workstation or personal computer and transmitted to a web server.

In the example of a gaming network, the information which passes between the gaming server and each end-station includes mainly game controller or similar inputs, player locations, player communications, and server notifications (such as in-game announcements). Typically, but not always, the game graphics are rendered and displayed locally, by the graphics chip in the player's computer, game console, or mobile device, thus avoiding the need to stream video over the connection. However, some cloud gaming services store and run their games in a virtual machine for streaming to users. Thus, rather than download and run these games locally on the user's gaming device, the user streams them from the cloud. In such a scenario, games are rendered on the gaming service and then streamed across the internet to the local device. Because these experiences are interactive and not passive (like other forms of media streaming, such as video streaming) input latency can be an issue.

Overall quality-of-service (QoS) to a gamer, using a typical web connection, is dependent upon both downstream QoS and upstream QoS. Thus user perceptions of quality-of-service for online gaming may differ from other network QoS such as media streaming, conferencing, voice over Internet (VoIP), or data access. In general, gaming networks have asymmetrical needs. Downstream feeds of video and audio signals need high downstream bandwidth for near real-time performance. In contrast, upstream control instructions have low bandwidth overhead but require low latency routing. In order to effectively allocate network resources, it is desirable to provide gaming networks with QoS custom-fitted to the specific needs of online gaming.

As noted above, online gaming applications are particularly sensitive to latency, or the amount of time a data packet uses to make a roundtrip to the gaming service and back. When latency gets too high when playing a game online, users begin to experience lag. For example, a player using a connection with high latency may move a game controller, and the move is reported to the gaming service. The server acknowledges the reported movement and sends a response reflecting this movement in the online game. The server response, as reflected in the game graphics, is then rendered and displayed locally. However, when the connection experiences higher latency, the player is question might see the movement subject to a delay, as compared to the other players.

There are a number of factors that impact latency, including, but not limited to:
The physical distance between the end-station and the server. The farther away the server is geographically, the greater is the number of “hops” that the signal travels between the end-station and the server, resulting in a longer journey which translates into higher latency.
Traffic congestion between the end-station and the gaming service.
Internet connection type and speed. For example, certain types of internet connections, such as satellite internet, exhibit more latency than others. Internet networks using fiber-optic cables have lower latency than networks using traditional cable connections.
Wireless connections, such as Wi-Fi, often add delay to a connection, because it requires an additional translation step between the gaming device and the internet connection. Wi-Fi connections may also add delay when multiple devices are connected to one router, or when a device is located farther away from the router.
Out-of-date hardware drivers, firmware, and operating systems may also contribute to communication delays.

In a non-limiting example, the present disclosure may operate within the context of a local area network (LAN) comprising one or more end gaming devices, e.g., user-devices or end-stations (STAs). A LAN may be connected to the Internet through an access point (AP) and/or a gateway, such as a broadband modem and/or router. In a typical LAN environment, a user may access the Internet by connecting a client device (which may be a wireless device) to a server on the Internet, via intermediate devices and networks. In some implementations, a client device may be connected to a LAN configured to communicate with servers on a wide area network (e.g., the Internet) via an access network. In some embodiments, a LAN may be a wireless local area network (WLAN), which includes, e.g., wireless STAs connected through a wireless AP, e.g., a wireless router. In some embodiments, STAs within a LAN can be, but are not limited to, a gaming console, a tablet, a desktop computer, a laptop computer, a handheld computer, a smartphone, or a combination of any these data processing devices or other data processing devices.

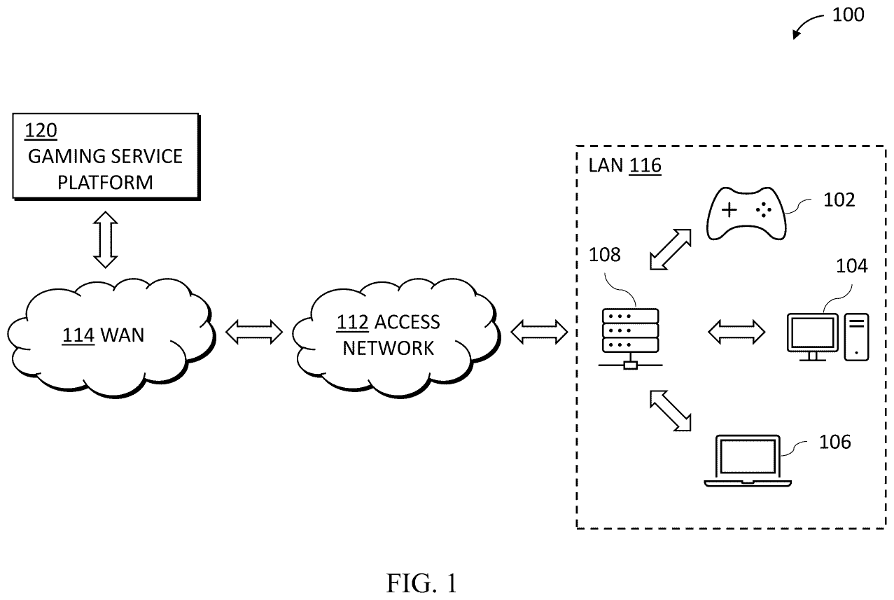

FIG. 1 illustrates an exemplary gaming network environment 100 between an end-station and a gaming service platform 120, in which the present technique for real-time monitoring and evaluating of the overall quality of an online gaming service connection may be realized, according to some embodiments of the present disclosure.

Gaming network environment 100 includes one or more gaming devices, e.g., end-stations (STAs) 102 (a gaming console), 104 (a desktop or gaming computer) and/or 106 (a laptop computer), communicably connected to gaming service platform 120 via local area network (LAN) 116, access network 112 and wide area network 114. However, each of STAs 102-106 can represent other forms of computing devices, e.g., a desktop computer, any handheld device, a tablet, a cellular telephone, a smartphone, a network appliance, a media player, or a combination of any these devices.

LAN 116 includes AP 108 and STAs 102-106. LAN 116 may be connected with the access network via a broadband modem. LAN 116 can include any computer network that covers a limited geographic area (e.g., a home, school, computer laboratory, or office building) using a wired or wireless (WLAN) distribution method. Client devices (e.g., STAs 102-106) may associate with an AP (e.g., AP 108) to access LAN 116 using any suitable communication protocol or standard. For example, LAN 116 may be a WLAN, e.g., a Wi-Fi network.

For exemplary purposes, LAN 116 is illustrated as including multiple STAs 102-106; however, LAN 116 may include only one of STAs 102-106. In some implementations, LAN 116 may be, or may include, one or more of a bus network, a star network, a ring network, a relay network, a mesh network, a star-bus network, a tree or hierarchical network, and the like.

AP 108 can include a network-connectable device, such as a hub, a router, a switch, a bridge, or any other access point. The network-connectable device may also be a combination of devices, such as a Wi-Fi router that can include a combination of a router, a switch, and an AP. Other network-connectable devices can also be utilized in implementations of the subject technology. AP 108 can allow client devices (e.g., STAs 102-106) to connect to wide area network 114 via access network 112.

In some aspects, STAs 102-106 may communicate through a communication interface (not shown), which may include digital signal processing circuitry where necessary. The communication interface may provide for communications under various modes or protocols, for example, Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. For example, the communication may occur through a radio-frequency transceiver (not shown). In addition, short-range communication may occur, for example, using a Bluetooth, Wi-Fi, or other such transceiver.

Gaming service platform 120 may be a system or device having a processor, a memory, and communications capability for providing content and/or services to the STAs in the gaming and/or other and/or additional service categories. In some example aspects, gaming service platform 120 can be a single computing device, for example, a computer server. In other embodiments, gaming service platform 120 can represent more than one computing device, e.g., multiple servers, working together to perform the actions of a gaming service platform (e.g., using cloud computing). Further, gaming service platform 120 can represent various forms of internet service platform including, but not limited to, an application server, a proxy server, a network server, an authentication server, an electronic messaging server, a content server, a server farm, etc.

A user may interact with the content and/or services provided by gaming service platform 120 through a client application installed at STAs 102-106. Alternatively, the user may interact with the system through a web browser application at STAs 102-106. Communication between STAs 102-106 and gaming service platform 120 may be facilitated through LAN 116, access network 112 and/or wide area network 114.

Access network 112 can include, but is not limited to, a cable access network, public switched telephone network, and/or fiber optics network to connect wide area network 114 to LAN 116. Access network 112 may provide last mile access to the Internet. Access network 112 may include one or more routers, switches, splitters, combiners, termination systems, central offices for providing broadband services.

Wide area network 114 can include, but is not limited to, a large computer network that covers a broad area (e.g., across metropolitan, regional, national or international boundaries), for example, the Internet, a private network, a cellular network, or a combination thereof connecting any number of mobile clients, fixed clients, and servers. Further, wide area network 114 can include, but is not limited to, any of the following network topologies, including a bus network, a star network, a ring network, a mesh network, a star-bus network, tree or hierarchical network, and the like. Wide area network 114 may include one or more wired or wireless network devices that facilitate device communications between STAs 102-106 and gaming service platform 120, such as switch devices, router devices, relay devices, etc., and/or may include one or more servers.

Using the example of gaming network environment 100, a typical gaming service connection includes downstream data packets originating in gaming service platform 120, and transmitted over WAN 114 and routed to AP 108 via access network 112. AP 108 is connected to a gaming device, e.g., gaming console 102 (or any other device performing as a game console, for example laptop computer 104 or desktop computer 106). In similar fashion, upstream data packets originate in game console 102 and are routed to gaming service platform 120 via access network 112 and WAN 114.

In a non-limiting example, the present technique provides for modifying an online gaming network, such as exemplary gaming network environment 100, to incorporate the present technique. For example, an agent of the present disclosure may be added to gaming network environment 100 to obtain the desirable features the present disclosure. In some embodiments, an agent of the present disclosure may be integrated as a node of gaming network environment 100, for example, within access network 112, AP 108, or otherwise. The present agent monitors and analyzes the telemetry data over a gaming service connection to determine a set of features associated with the service connection. The agent then assigns a score to the connection, based on the determined features.

Accordingly, in some embodiments, the present technique provides for an agent which continuously monitors a gaming service instance (which may comprise one or more individual data connections) over an online gaming network, to continuously evaluate the telemetry data performance of the network path from sender to target. In some embodiments, the present technique provides for monitoring a gaming network path response time, or network path latency, to determine a plurality of parameters associated with the amount of time required for a packet to travel across a network path from sender to target in both ways.

In some embodiments, the present technique specially measures the following parameters:
Latency: The amount of time a data packet uses to make a roundtrip between an end-station and the gaming service.
Jitter: The variation in latency as measured in the variability over time of the end-to-end delay across a network.
Packet loss: The rate of dataframe loss, i.e., dataframes that should have been forwarded by a network but did not reach their destination. Packet loss may be detected by comparing sequential numbers of downstream control packets sent to client and sequential numbers extracted from upstream packets received from client. The ratio of the number of lost packets to the number of downstream control packets defined a packet-loss ratio.
In this regards, the Internet Protocol (IP) is designed as a best-effort rather than a guaranteed delivery service. Therefore, packet loss over network paths should be taken into consideration when determining QoS. Generally, packet loss occurs when one or more packets of data travelling across a computer network fail to reach their destination. Packet loss is either caused by errors in data transmission or network congestion. Thus, when reliable delivery is necessary, packet loss increases latency due to the additional time needed for retransmission, which negatively affects user QoE. To avoid some of these issues, the Internet Protocol allows for routers to drop packets if the router or a network segment is too busy to deliver the data in a timely fashion. The dropping of packets by network nodes provides an indication to senders that the network is congested.

In some embodiments, the present technique uses these parameters to calculate and assign an overall quality score to the gaming service instance. In some examples, the service instance quality score can be represented on a scale of between 0-100, or using any other suitable scoring scale. In some embodiments, the service instance quality score may then allow the present technique to assess an overall Quality of Experience (QoE) associated with the gaming service instance, based on a scoring scale of 0-100:
Satisfactory Status (Score 75-100): The gaming service instance provides a satisfactory level of QoE.
Advisory Status (Score 50-74): The gaming service instance generally provides an adequate level QoE, however, the QoE is unstable and may be negatively impacted in the case of an increase in network data traffic or similar factors.
Critical Status (Score 25-49): The gaming service instance provides an inadequate level of QoE.
Inoperative Status (Score 0-24): The gaming service instance is inoperative, such that an end-deice is unable to connect to a gaming platform, experiences frequent disconnections, and/or is unable to execute a gaming application which requires a real-time data connection.

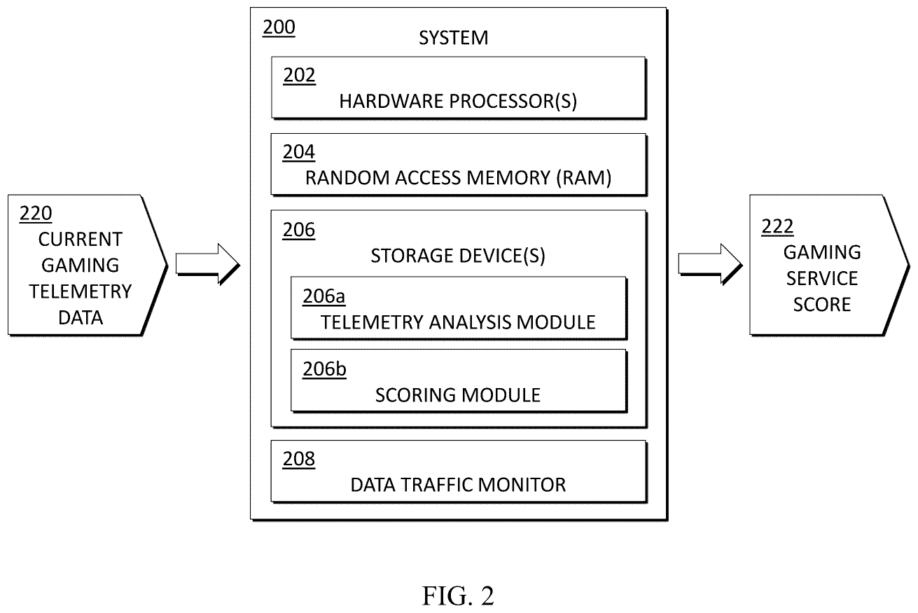

FIG. 2 shows a block diagram of an exemplary system 200 for real-time monitoring and evaluating of the overall quality of an online gaming service connection, according to some embodiments of the present disclosure.

System 200 may include one or more hardware processor(s) 202, a random-access memory (RAM) 204, one or more non-transitory computer-readable storage device(s) 206, and a data traffic monitor 208. Components of system 200 may be co-located or distributed, or the system may be configured to run as one or more cloud computing ‘instances,’ ‘containers,’ ‘virtual machines,’ or other types of encapsulated software applications, as known in the art.

Storage device(s) 206 may have stored thereon program instructions and/or components configured to operate hardware processor(s) 202. The program instructions may include one or more software modules, such as telemetry analysis module 206a and scoring module 206b. The software components may include an operating system having various software components and/or drivers for controlling and managing general system tasks (e.g., memory management, storage device control, power management, etc.), and facilitating communication between various hardware and software components. System 200 may operate by loading instructions of the various software module 206a and/or scoring module 206b into RAM 204 as they are being executed by processor(s) 202.

Data traffic monitor 208 may be configured to continuously monitor one or more gaming service instances over data communication networks. Data traffic monitor 208 may monitor and capture gaming telemetry data 220, including, but not limited to, data packets, user data, or control information associated with various information channels (e.g., control channels, data channels, and information related to managing service discovery over network connections). Gaming telemetry data 220 received at data traffic monitor 208 may be processed and transmitted to telemetry analysis module 206a to other components of system 200.

In some embodiments, data traffic monitor 208 may monitor and capture telemetry data, captured through active and/or passive probing of endpoint devices. In some embodiments, probing by data traffic monitor 208 may entail sending one or more of the following probes:
DHCP probes with helper addresses.
SPAN probes, to get messages in INIT-REBOOT and SELECTING states, use of ARP cache for IP/MAC binding, etc.
Netflow probes.
HTTP probes to obtain information such as the OS of the device, Web browser information, etc.
RADIUS probes.
SNMP to retrieve MIB object or receives traps.
DNS probes to get the Fully Qualified Domain Name (FQDN).
Active or SNMP scanning to retrieve the MAC address of a device or other types of information.

In some embodiments, telemetry data captured by data traffic monitor 208 may also include data packets, user data, or control information associated with various information channels (e.g., control channels, data channels, and information related to managing service discovery over network connections). Information received at data traffic monitor 208 may be processed and transmitted to telemetry analysis module 206a and/or to other components of system 200.

In some embodiments, data traffic monitor 208 may be completely software based, hardware based, or a combination of both. Data traffic monitor 208 may comprise one or more monitoring points, which may be implemented in software and/or hardware devices distributed over a plurality of network nodes. In some cases, data traffic monitor 208 may be implemented by a vendor, such as an ISP, to monitor network data traffic over a backbone or access network, where the data traffic is associated with a plurality of LANs serviced by the ISP.

In some embodiments, input gaming telemetry data 220 captured by data traffic monitor 208 originate in wired networks, but can also originate in wireless networks and virtual environments. In some examples, data traffic monitor 208 may include a circuit or circuitry for monitoring and identifying one or more attributes of a connection. In some embodiments, data traffic monitor 208 may be configured to monitor and determine, e.g., connection throughput (e.g., connection bitrate, byterate, packets per second, etc.). In some embodiments, data traffic monitor 208 may comprise a ‘sniffer’ or network analyzer designed to capture telemetry data on a network. In some embodiments, data traffic monitor 208 may employ any suitable hardware and/or software tool to capture telemetry data samples. For example, data traffic monitor 208 may be deployed to monitor one or more access networks, access points, end devices, and/or hosts, to capture telemetry data sent to or received from the Internet. In some embodiments, data traffic monitor 208 may be configured to determine a corresponding source or application associated with captured telemetry data. In some embodiments, data traffic monitor 208 may be configured to timestamp and label captured telemetry data with its associated source or application.

In some embodiments, telemetry analysis module 206a may be configured to receive input gaming telemetry data 220, as captured by data traffic monitor 208, and to preprocess and/or process and analyze the input gaming telemetry data 220 according to any desirable or suitable analysis technique, procedure or algorithm. In some embodiments, telemetry analysis module 206a may be configured to perform any one or more of the following: data cleaning, data filtering, data normalizing, and/or feature extraction and calculation. In some embodiments, the instructions of telemetry analysis module 206a cause system 200 to calculate and output an overall quality score 222 associated with the service connection.

System 200 as described herein is only an exemplary embodiment of the present invention, and in practice may be implemented in hardware only, software only, or a combination of both hardware and software. In various embodiments, system 200 may comprise a dedicated hardware device, or may be implement as a hardware and/or software module into an existing device, e.g., an AP, such as AP 108 within LAN 116 shown in FIG. 1, or may be part of a remote server, e.g., gaming service platform 120 shown in FIG. 1. System 200 may have more or fewer components and modules than shown, may combine two or more of the components, or may have a different configuration or arrangement of the components. System 200 may include any additional component enabling it to function as an operable computer system, such as a motherboard, data busses, power supply, a network interface card, a display, an input device (e.g., keyboard, pointing device, touch-sensitive display), etc. (not shown). Moreover, components of system 200 may be co-located or distributed, or the system may be configured to run as one or more cloud computing ‘instances,’ ‘containers,’ ‘virtual machines,’ or other types of encapsulated software applications, as known in the art.

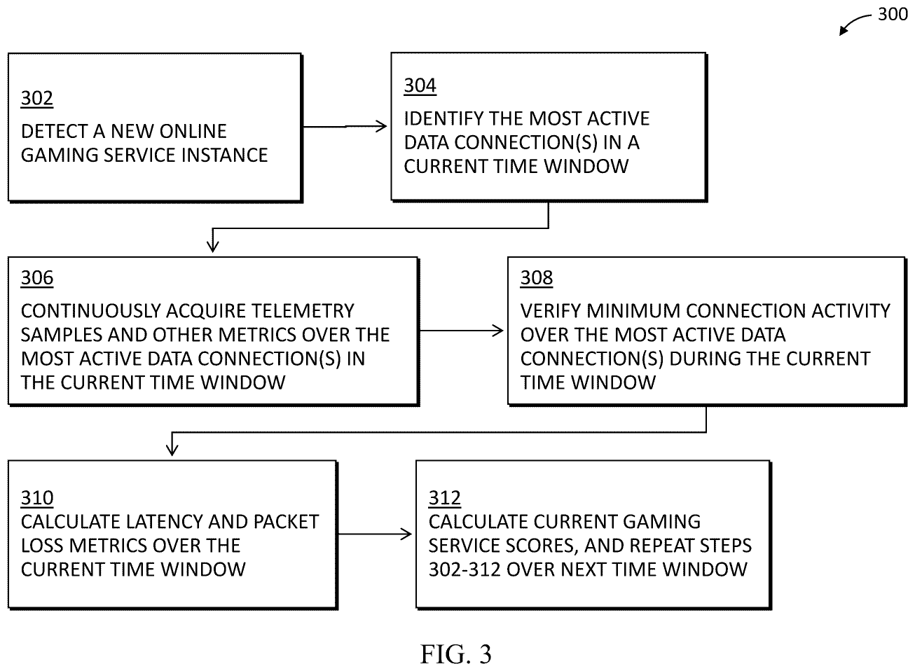

The instructions of system 200 will now be discussed with reference to the flowchart of FIG. 3 which illustrates the functional steps in a method 300 for real-time monitoring and evaluating of the overall quality of an online gaming service connection, according to some embodiments of the present disclosure. The various steps of method 300 will be described with continuous reference to exemplary gaming network environment 100 shown in FIG. 1, and to exemplary system 200 shown in FIG. 2.

The various steps of method 300 may either be performed in the order they are presented or in a different order (or even in parallel), as long as the order allows for a necessary input to a certain step to be obtained from an output of an earlier step. In addition, the steps of method 300 may be performed automatically (e.g., by system 200 of FIG. 2), unless specifically stated otherwise. In addition, the steps of FIG. 3 are set forth for exemplary purposes, and it is expected that modification to the flowchart is normally required to accommodate various network configurations and network carrier business policies.

In some embodiments, the steps of method 300 may be performed recursively, over consecutive time windows, over all or part of the duration of an online gaming service session. In some embodiments, the time windows have a duration of, e.g., between 1-240 seconds. However, other time windows having durations that are shorter or longer may be used. In some embodiments, the time windows over which the steps of method 300 are performed recursively may partly overlap.

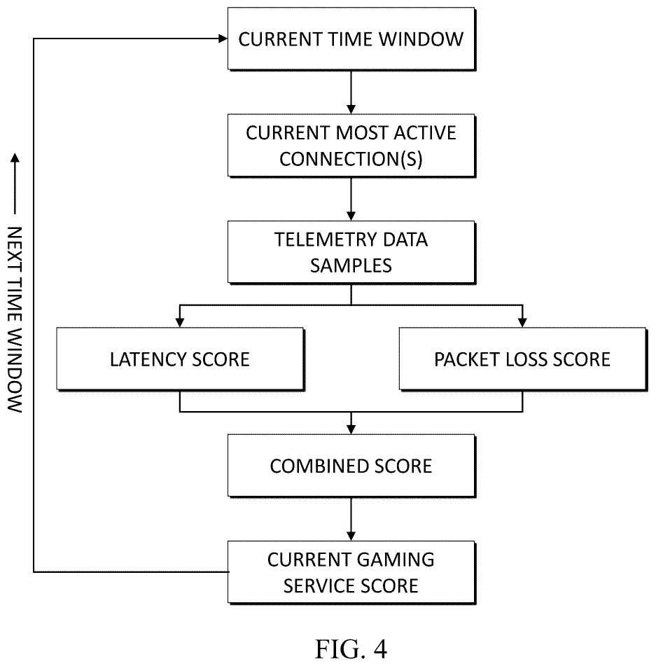

FIG. 4 provides an overview of the steps of method 300, performed recursively over time windows. As can be seen, the steps of method 300 are repeated recursively over consecutive time windows, over telemetry data metrics acquired from the most active data connection comprising input gaming telemetry data 220. In some embodiments, the instructions of scoring module 206b may cause system 200 to combine the results of the one or more scoring algorithms, e.g., based on predefined functions (e.g., a minimum function) or by applying predefined weights, to produce the final gaming score 222 on a scale of 0-100 for the gaming service instance.

Method 300 begins in step 302, when an online game participant transmits a game session initiation. For example, with reference to FIG. 1, STA 102 (a gaming console) within LAN 116 may transmit a session request message to establish a new gaming service connection with gaming service platform 120.

In some cases, the gaming service resources may be deployed across one or more associated domains, e.g., multiple domains. In such cases, in order to fetch the service, STA 102 must open two or more parallel data connections associated with the multiple resources comprising the requested service. Thus, a gaming service connection may comprise multiple active connections collectively providing a single gaming service instance.

In some embodiments, the instructions of data traffic monitor 208 may cause system 200 to detect a new service instance which includes one or more data traffic connections established within the context of the gaming network environment. As an example, system 200 or a portion thereof may be implemented, e.g., as a dedicated hardware device, or may be implement as a hardware and/or software module into an existing device, e.g., an AP, such as AP 108 within LAN 116 shown in FIG. 1, or may be part of a remote server, e.g., gaming service platform 120 shown in FIG. 1. Specifically, the instructions of data traffic monitor 208 may cause system 200 to detect a new service instance, and to continuously monitor the one or more data connections associated with the gaming service instance.

In some embodiments, the instructions of data traffic monitor 208 may cause system 200 to determine whether the service instance is associated with online gaming. For example, system 200 may be configured to determine that a new service instance is associated with online gaming based on connection parameters such as, but not limited to, domain name, IP address, and/or port numbers. In some embodiments, system 200 may perform these checks with respect to each of the multiple data connections associated with the service instance. In some embodiments, system 200 may be configured to determine that a new service instance is associated with online gaming based on a trained machine learning model classifier configured to output a classification of input telemetry data as belonging to one or more specified service categories, e.g., online gaming.

In some embodiments, a domain name may be determined using a Secure Socket Layer (SSL) certificate, which provides a fully qualified domain name associated with a server as verified by a trusted third party service. For example, a reverse DNS lookup or reverse DNS resolution (rDNS) may be carried out by data traffic monitor 208 to determine the domain name associated with an IP address. In other examples, data traffic monitor 208 may determine port numbers associated the IP address, and/or a transport protocol, e.g., Transmission Control Protocol (TCP) and the User Datagram Protocol (UDP). In the case of port number ranges, because many Internet resources use a known port or port ranges on their local host as a connection point to which other hosts may initiate communication, data traffic monitor 208 may analyze TCP SYN packets to know the server side of a new client-server TCP connection.

In some embodiments, associating a service instance with online gaming may be based on a URL or a server IP address associated with a known domain found, e.g., in repository of domain names associated with online gaming. For example, known domain names associated with online gaming may be identified and added to a database of domain name maintained by system 200, e.g., on storage device 206. In some embodiments, such detection may be further supported by, e.g., an expression or a string (e.g., a regex) which may be associated with a particular gaming application or service provider, an expected port range associated with the service type, or an expected protocol associated with the service provider.

In some embodiments, a database of known domain names associated with online gaming online may be obtained using, e.g., a dedicated crawler configured to systematically browses the Internet for the purpose of identifying and indexing domain names based on a type, content, etc. A crawler typically travels over the Internet and accesses resources. The crawler inspects, e.g., the content or other attributes of resources. The crawler then follows hyperlinks to other resources. The results of the crawling are then extracted into a repository, which may be queried to find content that is relevant to a particular task. Thus, for example, a URL or IP address associated with a service being provided to an STA in LAN 116 may be matched with an entry in a domain repository maintained by system 200. In such case, the service may be determined to be a category of service associated with the matched domain name.

In some embodiments, system 200 may be configured to determine that a new service instance is associated with online gaming by applying one or more trained machine learning models configured to perform a classification task which classifies input telemetry data as associated with online gaming service.

With reference back to FIG. 3, in step 304, the instructions of data traffic monitor 208 may cause system 200 to select, for a current time window, a subset comprising the most active data connections from among the one or more data connections which may be associated with the gaming service instance detected in step 302. In some embodiments, the instructions of data traffic monitor 208 may cause system 200 to select the single most active data connection from among the data connections which may be associated with the gaming service instance detected in step 302. In some embodiments, the instructions of data traffic monitor 208 may cause system 200 to select the top two most active data connections from among the data connections which may be associated with the gaming service instance detected in step 302. In some embodiments, the instructions of data traffic monitor 208 may cause system 200 to select another specified number of the most active data connections from among the data connections which may be associated with the gaming service instance detected in step 302, such as between 3-8 data connections.

In some embodiments, selecting the most active data connections may be based, at least in part, on maximum and/or average upstream and downstream data traffic measured over each individual data connection making up the gaming service instance. In some embodiments, the data traffic may be measured in bits per second, bytes per second, and/or packets per second. In some embodiments, detecting data connection activity may be performed continuously in real time, over consecutive time windows of predetermined duration. In some embodiments, the consecutive time windows may have a duration between 1-240 seconds.

With continued reference to FIG. 3, in step 306, the instructions of data traffic monitor 208 may cause system 200 to capture telemetry data samples as well as latency and packet drop metrics over the current time window, from the most active data connections identified in step 304. In some embodiments, step 306 may comprise acquiring telemetry samples and data connection metrics over the current time window, from only the most active data connection from among the data connections which may be associated with the gaming service instance detected in step 302. In some embodiments, step 306 may comprise acquiring telemetry samples and data connection metrics over the current time window, from the top two most active data connections from among the data connections which may be associated with the gaming service instance detected in step 302. In some embodiments, step 306 may comprise acquiring telemetry samples and data connection metrics over the current time window, from another specified number of the most active data connections from among the data connections which may be associated with the gaming service instance detected in step 302, such as between 3-8 most active data connections.

In some embodiments, the instructions of data traffic monitor 208 may cause system 200 to employ a ping protocol to continuously test the connectivity to gaming service platform 120. A ping utility indicates whether a specified destination server is reachable, and the time it will take to send and receive data from the server. Ping and/or similar utilities work by sending Internet Control Message Protocol (ICMP) echo request packets to at least one IP address associated with gaming service platform 120. The ping utility measures the round-trip time for messages sent from the originating node to a destination computer. If an echo reply packet is not received within a defined time period, connectivity to that device is assumed to be down.

Accordingly, in some embodiments, the instructions of data traffic monitor 208 may cause system 200 to conduct repeated ping tests over the current time window, with respect to the one or more most active data connections comprising the gaming service instance detected in step 302 and identified in step 306.

For example, the instructions of data traffic monitor 208 may cause system 200 to conduct repeated ping tests over the current time window, with respect to the most active data connection from among the data connections which may be associated with the gaming service instance detected in step 302. In some embodiments, the instructions of data traffic monitor 208 may cause system 200 to conduct repeated ping tests over the current time window, with respect to the top two most active data connections from among the data connections which may be associated with the gaming service instance detected in step 302. In other embodiments, the instructions of data traffic monitor 208 may cause system 200 to conduct repeated ping tests over the current time window, with respect to another specified number of the most active data connections from among the data connections which may be associated with the gaming service instance detected in step 302, such as between 3-8 most active data connections.

In each such case, the ping tests may be performed repeatedly. For example, the ping tests may be repeated at intervals of between 0.01-240 seconds over the current time window, or at any other desired interval over the current time window. In some embodiments, the instructions of data traffic monitor 208 may cause system 200 to continuously acquire and store, in real time, the results of the ping test measurements over the current time window with respect to the one or more most active data connections, e.g., in a repository on storage device 206.

In some embodiments, the instructions of data traffic monitor 208 may cause system 200 to employ a traceroute and/or a similar utility that traces a packet from source to destination, and shows the number of steps (hops) required to reach there, along with the duration of each step (hop). Traceroute and/or similar utilities work by sending packets of data with a low survival time (Time to Live—TTL) which specifies how many steps (hops) can the packet survive before it is returned. When a packet cannot reach the final destination and expires at an intermediate step, that node returns the packet and identifies itself. Thus, by increasing the TTL gradually, the trace is able to identify the intermediate hosts. If any of the hops comes back with a “request timed out,” this may denote network congestion and a reason for slow loading Web pages and dropped connections.

Accordingly, in some embodiments, the instructions of data traffic monitor 208 may cause system 200 to conduct repeated traceroute tests over the current time window, with respect to the one or more data connections comprising the gaming service instance detected in step 302. For example, the instructions of data traffic monitor 208 may cause system 200 to conduct repeated traceroute tests over the current time window, with respect to the most active data connection from among the data connections which may be associated with the gaming service instance detected in step 302. In some embodiments, the instructions of data traffic monitor 208 may cause system 200 to conduct repeated traceroute tests over the current time window, with respect to the top two most active data connections from among the data connections which may be associated with the gaming service instance detected in step 302. In other embodiments, the instructions of data traffic monitor 208 may cause system 200 to conduct repeated traceroute tests over the current time window, with respect to another specified number of the most active data connections from among the data connections which may be associated with the gaming service instance detected in step 302, such as between 3-8 most active data connections.

In each such case, the traceroute tests over the one or more data connections may be performed continuously over the current time window. In some embodiments, the traceroute tests over one or more data connections may be repeated at intervals of between 0.01-240 seconds over the current time window, with respect to, or at any other desired interval over the current time window, with respect to. In some embodiments, the instructions of data traffic monitor 208 may cause system 200 to continuously acquire and store, in real time, the results of traceroute measurements over the current time window, with respect to the one or more data connections, e.g., in a repository on storage device 206.

For example, the instructions of data traffic monitor 208 may cause system 200 to acquire packet loss rates over the current time window, with respect to the most active data connection from among the data connections which may be associated with the gaming service instance detected in step 302. In some embodiments, the instructions of data traffic monitor 208 may cause system 200 to acquire packet loss rates over the current time window, with respect to the top two most active data connections from among the data connections which may be associated with the gaming service instance detected in step 302. In other embodiments, the instructions of data traffic monitor 208 may cause system 200 to acquire packet loss rates over the current time window, with respect to another specified number of the most active data connections from among the data connections which may be associated with the gaming service instance detected in step 302, such as between 3-8 most active data connections.

In each such case, packet loss measurements may be performed continuously over a current time window. In some embodiments, the packet loss measurements over a current time window may be repeated at time intervals of between 0.01-240 seconds, or at any other desired interval. In some embodiments, the instructions of data traffic monitor 208 may cause system 200 to continuously acquire and store, in real time, the results of packet loss measurements over a current time window, e.g., in a repository on storage device 206.

In each such case, packet loss may be measured as a rate of dataframe loss, i.e., the percentage of dataframes that should have been forwarded by a network but were not. Thus, for example, packet loss rate measurements may be based on a ratio of ping and/or traceroute messages that failed to reach their destination and/or timed-out. Accordingly, if 100 ping and/or traceroute tests are conducted within a current time window, but only 70 were received in their respective destination, this indicated a packet loss rate of 30%.

With reference back to FIG. 3, in step 308, the instructions of data traffic monitor 208 may cause system 200 to verify that the most active data connections meet minimum data traffic thresholds. For example, the instructions of data traffic monitor 208 may cause system 200 to verify the activity levels of the single most active data connection from among the data connections which may be associated with the gaming service instance detected in step 302, the top two most active data connections, or another specified number of the most active data connections, as the case may be.

In some embodiments, the minimum data traffic thresholds may be based on maximum and/or average upstream and/or downstream data traffic measured over the respective data connection. In some embodiments, such minimum activity data traffic thresholds may be applied separately with respect to upstream and downstream data traffic paths, or only to one of the upstream or only to the downstream data traffic paths.

In some embodiments, in step 310, the instructions of telemetry analysis module 206a may cause system 200 to calculate latency and packet loss metric over the current time window, based on the telemetry data and data connection metrics acquired in step 306.

In one example, the instructions of telemetry analysis module 206a may cause system 200 to analyze the telemetry data and latency and packet drop metrics acquired in step 306, to calculate one or more of the following metrics over the current time window:
Latency: Packet roundtrip time mean, average, maximum, minimum, and/or standard deviation of the mean.
Packet loss: Packet loss rate mean, average, maximum, minimum, and/or standard deviation of the mean.
Data rates:
   Byterate mean, average, maximum, minimum, and/or standard deviation of mean.
   Packet rate mean, average, maximum, minimum, and/or standard deviation of mean.

In some embodiments, in step 312, the instructions of scoring module 206b may cause system 200 to apply one or more scoring algorithms to the metrics calculated in step 310, to calculate one or more current gaming service instance scores over the current time window, with respect to the gaming service instance identified in step 302.

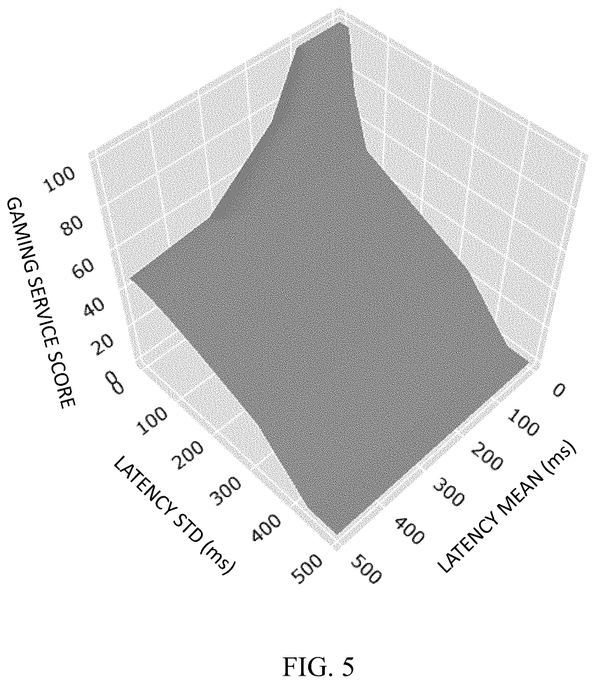

In some embodiments, the instructions of scoring module 206b may cause system 200 to calculate at least the following scores over the current time window:
Latency score: The latency score is based on the latency metrics (e.g., packet roundtrip metrics) calculated in step 310, by applying a predefined multivariate scoring function to the latency metrics, to calculate an overall latency score over the current time window, on a scale of between 0-100. In some embodiments, a predetermined score (e.g., an overall minimum latency score of 0) may be assigned in cases of no response to the latency tests from the target host. Another predetermined score (e.g., a maximum overall latency score of 100) may be assigned when the latency metrics that are consistent with minimal latency and delay over the gaming service instance, e.g., latency metrics that are below a predetermined threshold representing minimal latency and delay.
FIG. 5 shows a plot of an exemplary multivariate function of the present disclosure, which receives as input at least mean roundtrip time and standard deviation of roundtrip time over a current time window, and outputs an overall latency score for the current time window.
Packet loss score: The packet loss rate score is calculated by inputting the packet loss rate metrics calculated in step 310 into a one-variable monotonically rising function, to calculate an overall packet loss score of the gaming service instance, on a scale of between 0-100. In some embodiments, a predetermined score (e.g., a minimum overall packet loss score of 0) may be assigned in cases of a loss rate of 100%, i.e., when virtually all packets are lost. Conversely, another predetermined score (e.g., a maximum overall packet loss score of 100) may be assigned in cases of a loss rate of 0%, i.e., when virtually all packets reach their destination.

In some embodiments, the instructions of scoring module 206b may cause system 200 to combine the results of the one or more scoring algorithms, e.g., based a predefined function (e.g., a minimum function) or by applying predefined weights, to produce an overall gaming service score 222 for the gaming service instance identified in step 302. The gaming service instance score can be represented on a scale of between 0-100.

For example, the instructions of scoring module 206b may then cause system 200 to calculate and assign an overall gaming service score 222, based on the lowest of the (i) the latency score, and (ii) packet loss score, calculated in step 312.

Finally, the instructions of scoring module 206b may cause system 200 to assess, based on the overall gaming service score 222, an overall Quality of Experience (QoE) associated with the gaming service instance, as one of:
Satisfactory Status (Score 75-100): The gaming service instance provides good QoE.
Advisory Status (Score 50-74): The gaming service instance currently provides good QoE, however, the QoE is unstable and may be negatively impacted in the case of an increase in network data traffic or similar factors.
Critical Status (Score 25-49): The gaming service instance provides inadequate QoE.
Inoperative Status (Score 0-24): The gaming service instance is inoperative, such that an end-deice is unable to connect to a gaming platform, experiences frequent disconnections, and/or unable to execute a gaming application which requires a real-time data connection.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Rather, the computer readable storage medium is a non-transient (i.e., not-volatile) medium.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, a field-programmable gate array (FPGA), or a programmable logic array (PLA) may execute the computer readable program instructions by utilizing state information of the computer readable program instructions to personalize the electronic circuitry, in order to perform aspects of the present invention. In some embodiments, electronic circuitry including, for example, an application-specific integrated circuit (ASIC), may be incorporate the computer readable program instructions already at time of fabrication, such that the ASIC is configured to execute these instructions without programming.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In the description and claims, each of the terms “substantially,” “essentially,” and forms thereof, when describing a numerical value, means up to a 20% deviation (namely, ±20%) from that value. Similarly, when such a term describes a numerical range, it means up to a 20% broader range—10% over that explicit range and 10% below it).

In the description, any given numerical range should be considered to have specifically disclosed all the possible subranges as well as individual numerical values within that range, such that each such subrange and individual numerical value constitutes an embodiment of the invention. This applies regardless of the breadth of the range. For example, description of a range of integers from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 4, and 6. Similarly, description of a range of fractions, for example from 0.6 to 1.1, should be considered to have specifically disclosed subranges such as from 0.6 to 0.9, from 0.7 to 1.1, from 0.9 to 1, from 0.8 to 0.9, from 0.6 to 1.1, from 1 to 1.1 etc., as well as individual numbers within that range, for example 0.7, 1, and 1.1.

The descriptions of the various embodiments of the present invention have been presented for purposes of illustration, but are not intended to be exhaustive or limited to the explicit descriptions. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the description and claims of the application, each of the words “comprise,” “include,” and “have,” as well as forms thereof, are not necessarily limited to members in a list with which the words may be associated.

Where there are inconsistencies between the description and any document incorporated by reference or otherwise relied upon, it is intended that the present description controls.

What is claimed is:

1. A system comprising:
at least one hardware processor; and
a non-transitory computer-readable storage medium having stored thereon program instructions, the program instructions executable by the at least one hardware processor to:
receive, at a communications network interface, telemetry data representing data connections associated with a gaming service instance provided to an end-device by a remote gaming server over the Internet,
select a subset of said data connections, based on data traffic measurements associated with each of said data connections,
recursively, with respect to each current time window:
(i) calculate a plurality of latency metrics over said subset of data connections,
(ii) determine a current latency score of said gaming service instance, based on said plurality of latency metrics,
(iii) update a current Quality of Service (QoS) rating for said gaming service instance, based, at least in part, on said current latency score, and
(iv) repeat steps (i)-(iii) with respect to a next time window.

2. The system of claim 1, wherein said subset of data connections comprises between 1-8 of said data connections having a highest rate of date traffic.

3. The system of claim 1, wherein said plurality of latency metrics comprises one or more of the following metrics representing packet roundtrip time values over said subset of data connections: mean, average, maximum, minimum, or standard deviation.

4. The system of claim 3, wherein said current latency score is determined by applying a multivariate function to at least two of said latency metrics.

5. The system of claim 1, wherein said calculating further comprises calculating a packet loss score, based on a plurality of packet loss metrics comprising one or more of the following metrics representing packet loss over said subset of data connections: mean, average, maximum, minimum, or standard deviation.

6. The system of claim 5, wherein said current QoS is updated based on one of the following methods: selecting the lowest of said latency and packet loss scores, or applying predefined weights to said latency and packet loss scores.

7. The system of claim 1, wherein said time window has a duration of between 1-240 seconds.

8. A computer-implemented method comprising:
receiving, at a communications network interface, telemetry data representing data connections associated with a gaming service instance provided to an end-device by a remote gaming server over the Internet;
selecting a subset of said data connections, based on data traffic measurements associated with each of said data connections;
recursively, with respect to each current time window:
(i) calculating a plurality of latency metrics over said subset of data connections,
(ii) determining a current latency score of said gaming service instance, based on said plurality of latency metrics,
(iii) updating a current Quality of Service (QoS) rating for said gaming service instance, based, at least in part, on said current latency score, and
(iv) repeating steps (i)-(iii) with respect to a next time window.

9. The computer-implemented method of claim 8, wherein said subset of data connections comprises between 1-8 of said data connections having a highest rate of date traffic.

10. The computer-implemented method of claim 8, wherein said plurality of latency metrics comprises one or more of the following metrics representing packet roundtrip time values over said subset of data connections: mean, average, maximum, minimum, or standard deviation.

11. The computer-implemented method of claim 10, wherein said current latency score is determined by applying a multivariate function to at least two of said latency metrics.

12. The computer-implemented method of claim 8, wherein said calculating further comprises calculating a packet loss score, based on a plurality of packet loss metrics comprising one or more of the following metrics representing packet loss over said subset of data connections: mean, average, maximum, minimum, or standard deviation.

13. The computer-implemented method of claim 12, wherein said current QoS is updated based on one of the following methods: selecting the lowest of said latency and packet loss scores, or applying predefined weights to said latency and packet loss scores.

14. The computer-implemented method of claim 8, wherein said time window has a duration of between 1-240 seconds.

15. A computer program product comprising a non-transitory computer-readable storage medium having program instructions embodied therewith, the program instructions executable by at least one hardware processor to:
receive, at a communications network interface, telemetry data representing data connections associated with a gaming service instance provided to an end-device by a remote gaming server over the Internet;
select a subset of said data connections, based on data traffic measurements associated with each of said data connections;
recursively, with respect to each current time window:
(i) calculate a plurality of latency metrics over said subset of data connections,
(ii) determine a current latency score of said gaming service instance, based on said plurality of latency metrics,
(iii) update a current Quality of Service (QoS) rating for said gaming service instance, based, at least in part, on said current latency score, and
(iv) repeat steps (i)-(iii) with respect to a next time window.

16. The computer program product of claim 15, wherein said subset of data connections comprises between 1-8 of said data connections having a highest rate of date traffic.

17. The computer program product of claim 15, wherein said plurality of latency metrics comprises one or more of the following metrics representing packet roundtrip time values over said subset of data connections: mean, average, maximum, minimum, or standard deviation.

18. The computer program product of claim 17, wherein said current latency score is determined by applying a multivariate function to at least two of said latency metrics.

19. The computer program product of claim 1, wherein said calculating further comprises calculating a packet loss score, based on a plurality of packet loss metrics comprising one or more of the following metrics representing packet loss over said subset of data connections: mean, average, maximum, minimum, or standard deviation.

20. The computer program product of claim 19, wherein said current QoS is updated based on one of the following methods: selecting the lowest of said latency and packet loss scores, or applying predefined weights to said latency and packet loss scores.
